(19) United States
(12) Patent Application Publication
(10) Pub. No.: US 2014/0196788 A1
(43) Pub. Date: Jul. 17, 2014

(54) Storage Tank Control Valve System

(71) Applicant: Dallas Taft, Kingston, PA (US)

(72) Inventor: Dallas Taft, Kingston, PA (US)

(21) Appl. No.: 13/740,321

(22) Filed: Jan. 14, 2013

(51) Int. Cl. F16K 31/02

(52) U.S. Cl. CPC F16K 31/02
USPC 137/1; 251/129.03

(57) ABSTRACT

A gas storage tank control valve system is presented. A valve controlling motor is electrically connected to a switch that is installed in a convenient location. Upon activation, the motor rotates the storage tank valve. An indicator visibly displays whether the liquid propane storage tank valve is open or closed.

### FIELD OF THE INVENTION

This invention relates generally to a storage tank control valve system, and in particular, to operation of a barbeque unit liquid propane storage tank valve.

### BACKGROUND OF THE INVENTION

Liquid propane is a versatile and widely used fuel. It is distributed and stored under pressure in tanks When released from the tank into atmospheric conditions the liquid propane becomes gaseous and is thereafter ignited to produce flame and heat.

Often the storage tank is placed in a location not conveniently accessible. For example, in a liquid propane fueled barbeque unit the storage tank is typically located underneath the cooking surface requiring bending and reaching to access the tank's valve. The difficulty of physically accessing the tank valve is further compounded for people with physical disabilities such as chronic back pain. Furthermore, because the liquid propane storage tank is typically located out of view it is not uncommon to forget to close the tank valve, creating the potential for wasted loss of propane from the tank with resulting environmental harm.

Accordingly, there is still a continuing need for improved liquid propane storage tank valve management designs. The present invention fulfills this need and further provides related advantages.

### BRIEF SUMMARY OF THE INVENTION

The storage tank control valve system enables the automated opening and closing of a liquid propane storage tank valve through the use of a control switch electrically connected to an actuator physically coupled to the liquid propane storage tank valve and/or to an auxiliary valve that is controlling the storage tank gas flow.

Optionally, the control switch is also connected to an indicator, for example, a light displayed on a main control panel of the barbecue unit, which indicates the state of the liquid propane storage tank valve.

One advantage of mounting the control switch in an easy to access location is that it provides convenience, negating the difficulty of having to manually reach for the liquid propane storage tank valve.

Another advantage of having the control switch and optional indicator mounted in plain view is that it increases the likelihood of remembering to close the liquid propane storage tank valve when not in use.

Yet another advantage is the ability to easily open and close a liquid propane storage tank valve fueling, for example, a barbecue unit.

Still another advantage is that once installed, the present invention negates the need to directly physically access the liquid propane storage tank valve.

Other features and advantages of the storage tank control valve system will be apparent from the following more detailed description of the preferred embodiments taken in conjunction with the accompanying drawings which illustrate, by way of example, the principles of the invention.

### BRIEF DESCRIPTION OF THE DRAWINGS

The accompanying drawings are included to provide a further understanding of the storage tank control valve system. These drawings are incorporated in and constitute a part of this specification, illustrate one or more embodiments of the storage tank control valve system, and together with the description, serve to explain the principles of the storage tank control valve system.

FIG. 1 is a perspective view of the storage tank control valve system in accordance with a first embodiment.

FIG. 2 is an exploded view of the storage tank control valve system of FIG. 1.

FIG. 3 is a top view of the storage tank control valve system in accordance with a first embodiment.

FIG. 4 is a planar section view at A of FIG. 3 of the storage tank control valve system in accordance with a first embodiment.

FIG. 5 is a top view of the storage tank control valve system in accordance with a second embodiment.

FIG. 6 is a planar section view at B of FIG. 5 of the storage tank control valve system in accordance with a second embodiment.

FIG. 7 is a planar section view at C of FIG. 5 of the storage tank control valve system in accordance with a second embodiment.

FIG. 8 is a perspective view of the storage tank control valve system on a barbeque unit.

FIG. 9 is a front view of the barbeque unit of FIG. 8.

Other features and advantages of the storage tank control valve system will be apparent from the following more detailed description of the preferred embodiments taken in conjunction with the accompanying drawings which illustrate by way of example the principles of the storage tank control valve system.

### DETAILED DESCRIPTION OF THE INVENTION

As required, detailed embodiments of the storage tank control valve system are disclosed; however, it is to be understood that the disclosed embodiments are merely exemplary of the invention that may be embodied in various forms. The figures are not necessary to scale, and some features may be exaggerated to show details of particular components. Therefore, specific structural and functional details disclosed are not to be interpreted as limiting, but merely as a basis for the claims and as a representative basis for teaching one skilled in the art to variously employ the storage tank control valve system. Where possible, like reference numerals have been used to refer to like parts in the several alternative embodiments.

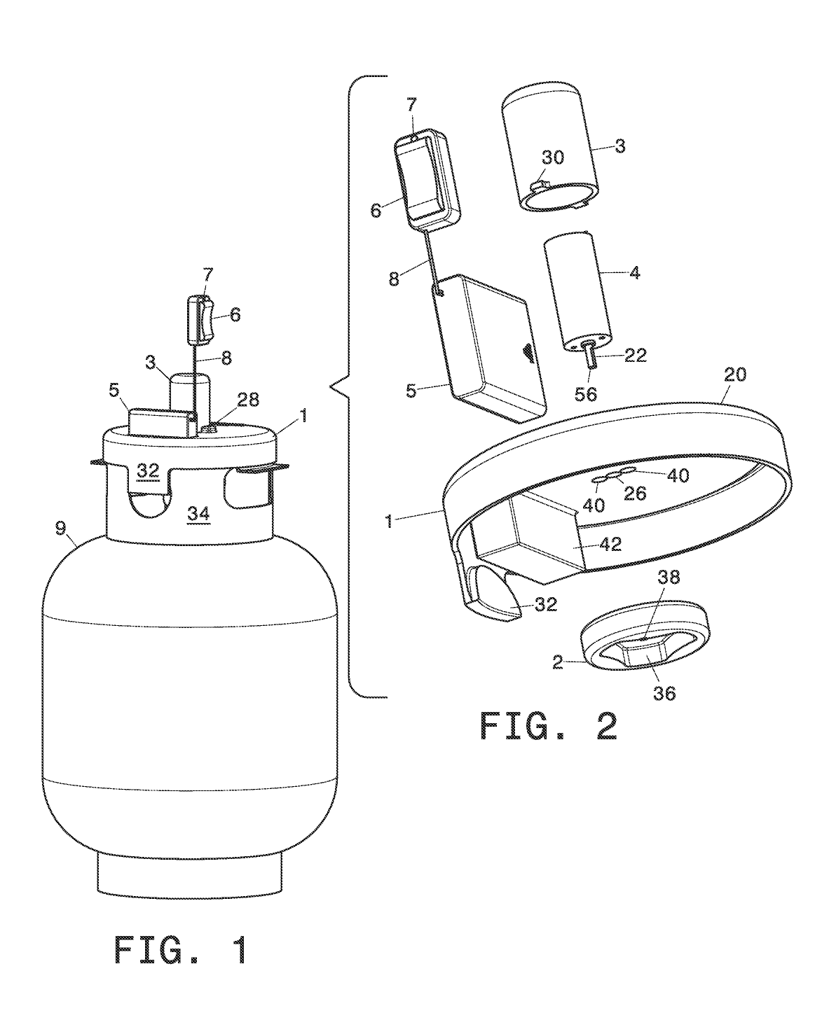

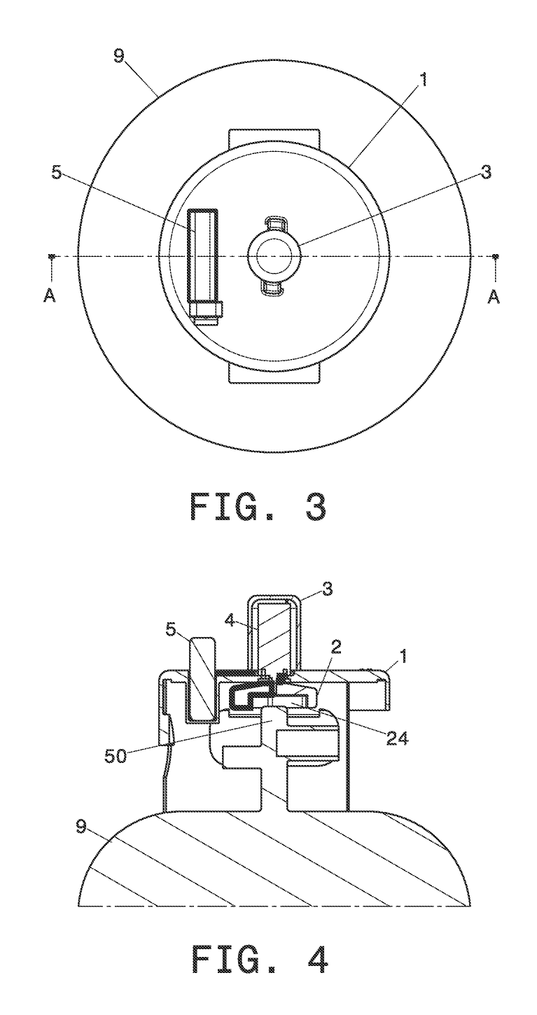

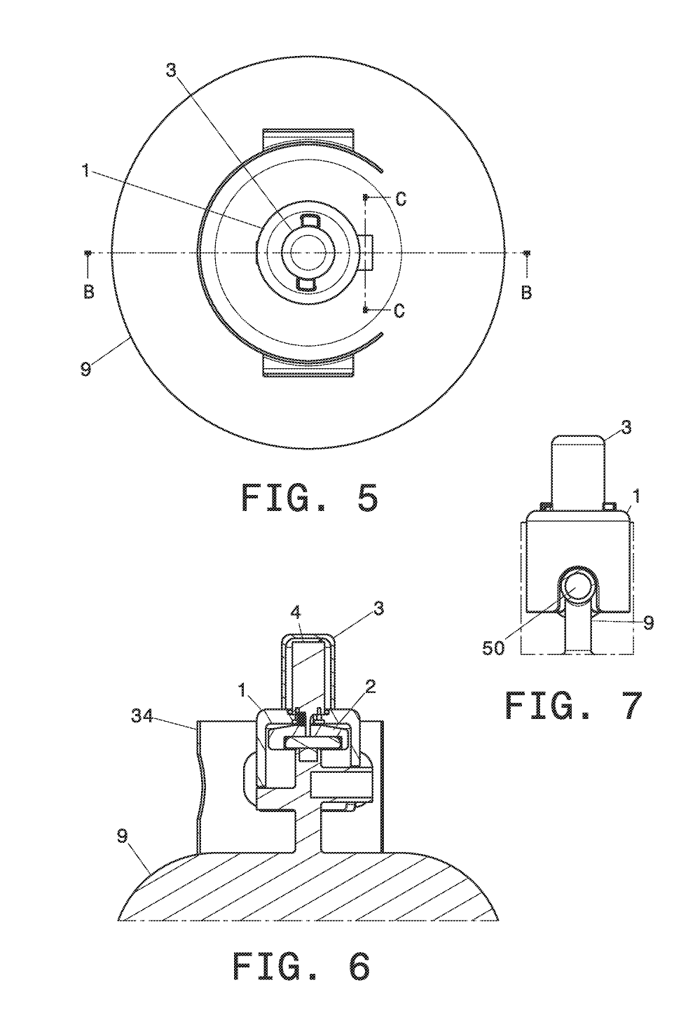

FIG. 1, FIG. 2, FIG. 3, and FIG. 4 illustrate a first preferred embodiment of the storage tank control valve system. FIG. 5, FIG. 6 and FIG. 7 illustrate a second preferred embodiment.

Turning now to FIGS. 1-4, a housing 1 is fabricated to rotationally restrictively engage the top of a storage tank, for example, a liquid propane storage tank 9. In the first preferred embodiment the housing 1 rotationally restrictive conformation is achieved by housing extension 32 fabricated to removably rotationally restrictively engage storage tank collar 34.

A motor 4 is mounted to the housing 1, for example, through mounting orifices 40, and comprises an adapter engagement member 22, for example, comprising an extended shaft 56 positioned in the same operative rotational axis as a liquid propane storage tank valve 50. Knob 24 controls valve 50. Preferably, the motor 4 is mounted to the housing exterior surface 20 with adapter engagement member 22 extending through a housing orifice 26 to operatively engage an adapter 2.

Optionally, housing 1 comprises a pocket 42 to contain, preferably removably contain, a battery pack 5. Battery pack 5 powers motor 4. Motor cap 3 is attached, preferably removably attached, to housing 1 by, for example, utilizing raised pockets 28 to removably receive flanges 30. Motor cap 3 is, for example, a cylinder that is open on one end and closed on the other end. The length and diameter of the motor cap 3 are sized to fit over the motor 4 with the flanges 30 fabricated at the open end.

Adapter 2 comprises, for example, a round disc that has a pocket 36 fabricated to intimately receive and operatively engage the liquid propane storage tank valve 52, for example through knob 24, and has a center orifice 38 which operatively mates with the adapter engagement member 22 thereby operatively transmitting motor torque to the valve knob 24.

The electrically driven motor 4 rotates the adapter engagement member 22 with effective torque to rotate the liquid propane storage tank valve knob 24. The motor 4 is electrically connected through wiring harness 8 to battery pack 5. Although in the preferred embodiment the battery pack 5 is contained within pocket 42, it is also contemplated that battery pack 5 is not restricted to that location. It is further contemplated that the motor 4 may receive its power from any known power source, for example, a plug connection to an electrical outlet, or from solar panels (not shown).

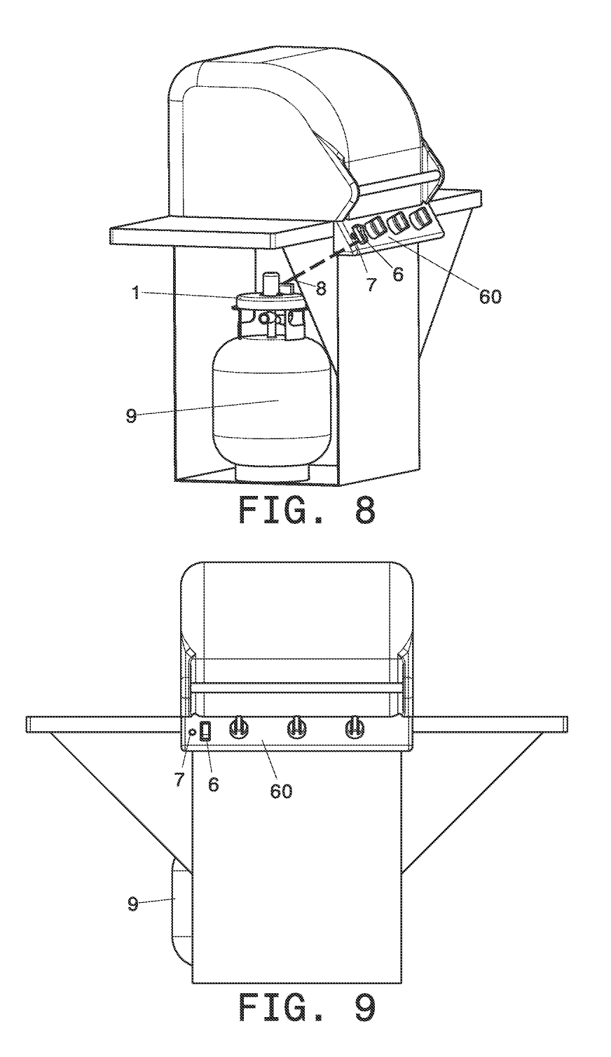

As shown in FIGS. 8 and 9, a motor control, for example, a switch 6 is electrically connected through the wire harness 8 to the battery pack 5, the motor 4 and an optional indicator 7, for example, an indicator light to display a predetermined valve knob 24 status.

Turning now to FIGS. 5-7, in a second embodiment the housing 1 is fabricated to interface with the valve fittings 50 of the liquid propane storage tank 9, conforming to the shape for stability and as an anti-rotation device. The housing 1 rests on the valve fitting 50, rather than extending out to rest on the collar portion 34 of the propane tank 9 as in the first embodiment. In all other respects, the embodiments are similar.

In use the housing 1 is rotationally restrictively attached to the top of the propane tank 9 with the adapter 2 oriented so that it operatively engages the propane tank valve knob 24. The adapter 2 transmits torque from the motor 4 to the propane tank valve knob 24 to rotate the propane tank valve knob 24 open and closed. The battery pack 5 provides power to the motor 4. The control switch 6 causes the motor 4 to rotate forward, reverse or stop. The indicator light 7 illuminates when the motor 4 rotates the tank valve knob 24 open and turns off when the motor 4 rotates in reverse to close the propane tank valve knob 24. The motor cap 3 is placed over the motor 4 for protection. The wiring harness 8 electrically connects the battery pack 5, the motor 4, the control switch 6 and optional indicator light 7.

Preferably the control switch 6 and indicator light 7 are remotely mounted from the motor 4, for example, onto a control panel 60 of the barbecue unit. In the preferred embodiments the control switch 6 is a spring toggle having 3 positions, forward, center, and reverse. In the forward position the motor 4 rotates and opens the tank valve knob 24. Releasing the control switch 6 will result in a return to the center position and deactivation of the motor 4. Pressing the control switch 6 in the reverse position will cause the motor 4 to rotate in the opposite direction thereby closing the tank valve knob 24. Releasing the control switch 6 will again return it to the center position and deactivate the motor 4.

It is further contemplated that the housing 1 and adapter 2 can be fabricated to operatively engage other types of gas pressure vessels in order to provide the same functionality, that is to remotely control the opening and closing of a tank valve. Variations could include, but are not limited to, adding one or more additional controlled external valves.

The component parts may be fabricated from plastic or any other effectively rigid and strong material. Optionally, the indicator 7 can be electrically connected to a relay (not shown) so that it illuminates when the motor 4 rotates one direction, and turns off when it rotates in the opposite direction.

The storage tank control valve system may be adapted to an existing barbecue unit or integrated with the manufacturing of a new barbecue unit.

Although the storage tank control valve system has been described in connection with specific examples and embodiments, those skilled in the art will recognize that the present invention is capable of other variations and modifications within its scope. These examples and embodiments are intended as typical of rather than in any way limiting on the scope of the present invention as presented in the appended claims.

What is claimed is:

1. A storage tank control valve system comprising:
a housing fabricated for rotationally restrictively engaging a top of a storage tank;
a motor mounted to the housing;
an adapter engagement member operatively engaging the motor to an adapter;
the adapter fabricated for operatively engaging a storage tank valve; and
a motor control remotely located from the motor operatively connected to a power source.

2. The system of claim 1 wherein the housing comprises an extension fabricated for removably rotationally restrictively engaging a storage tank collar.

3. The system of claim 1 wherein the adapter engagement member comprises an extended shaft fabricated in a rotational axis for operative engagement of the storage tank valve.

4. The system of claim 2 wherein the adapter engagement member comprises an extended shaft fabricated in a rotational axis for operative engagement of the storage tank valve.

5. The system of claim 1 wherein the housing comprises a power source pocket.

6. The system of claim 1 wherein the adapter comprises a disc comprising a first side having pocket fabricated to operatively receive a storage tank valve knob and a second opposite side operatively mating the adapter engagement member.

7. The system of claim 1 further comprising a storage tank having a valve, valve knob, and valve collar.

8. The system of claim 2 further comprising a storage tank having a valve, valve knob, and valve collar.

9. A storage tank control valve system comprising:
a housing comprising a power source pocket and a housing extension, the extension fabricated for removably rotationally restrictively engaging a storage tank collar;
a motor mounted to the housing;
an adapter engagement member operatively engaging the motor to an adapter, the engagement member comprising an extended shaft fabricated in a rotational axis for operative engagement of a storage tank valve;
the adapter fabricated for operatively engaging the storage tank valve; and
a motor control remotely located from the motor operatively connected to a power source;
wherein
the adapter comprises a disc comprising a first side having a pocket fabricated for operatively receiving a storage tank valve knob and a second opposite side operatively mating the adapter engagement member; and
the motor control comprises a switch and an indicator.

10. The system of claim 9 further comprising a storage tank having a valve, valve knob, and valve collar.

11. The system of claim 9 further comprising a storage tank having a valve, valve knob, and valve collar, and a barbeque unit comprising a control board containing the motor control.

12. A storage tank control valve system comprising:
a housing fabricated for removably rotationally restrictively interfacing a storage tank valve;
a motor mounted to the housing;
an adapter engagement member operatively engaging the motor to an adapter, the engagement member comprising an extended shaft fabricated in a rotational axis for operative engagement of the storage tank valve;
the adapter fabricated for operatively engaging the storage tank valve; and
a motor control remotely located from the motor operatively connected to a power source;
wherein
the adapter comprises a disc comprising a first side having a pocket fabricated for operatively receiving a storage tank valve knob and a second opposite side operatively mating the adapter engagement member; and
the motor control comprises a switch and an indicator.

13. The system of claim 12 further comprising a storage tank having a valve, valve knob, and valve collar.

14. The system of claim 12 further comprising a storage tank having a valve, valve knob, and valve collar, and a barbeque unit comprising a control board containing the motor control.

15. A method for remotely controlling a barbeque unit gas supply comprising the steps of:
connecting a storage tank control valve system to a gas supply tank;
operatively connecting the control valve system to a motor control; and
operating the motor control to control the gas supply;
wherein the storage tank control valve system comprises:
a housing rotationally restrictively engaging a top of the supply tank;
a motor mounted to the housing;
an adapter engagement member operatively engaging the motor to an adapter;
the adapter operatively engaging a supply tank valve; and
the motor control is remotely located from the motor and operatively connected to a power source.

16. The method of claim 15 wherein the housing comprises an extension removably rotationally restrictively engaging a supply tank collar.

17. The method of claim 15 wherein the adapter engagement member comprises an extended shaft in a rotational axis to operatively engage the supply tank valve.

18. The method of claim 16 wherein the adapter engagement member comprises an extended shaft in a rotational axis to operatively engage the supply tank valve.

19. The method of claim 15 wherein the housing comprises a power source pocket.

20. The method of claim 15 wherein the adapter comprises a disc comprising a first side operatively receiving a storage tank valve knob and a second opposite side operatively mating the adapter engagement member.
